(19) United States
(12) Patent Application Publication
(10) Pub. No.: US 2024/0147998 A1
(43) Pub. Date: May 9, 2024

(54) HERBICIDAL COMPOSITIONS COMPRISING IMIDAZOLINONE-BASED ACETOLACTATE SYNTHASE INHIBITORS AND USES THEREOF

(71) Applicant: Adama Agan Ltd., Ashdod (IL)

(72) Inventors: Daniel MELIKER, Ariel (IL); Sergio NAHMOUD, Ashdod (IL)

(73) Assignee: Adama Agan Ltd., Ashdod (IL)

(21) Appl. No.: 18/547,527

(22) PCT Filed: Feb. 22, 2022
(86) PCT No.: PCT/IL2022/050205

§ 371 Date: Aug. 23, 2023

Related U.S. Application Data
(60) Provisional application No. 63/153,003, filed on Feb. 24, 2021.

(51) Int. Cl. A01N 43/50; A01N 25/02; A01N 25/30; A01N 37/22; A01N 43/54; A01P 13/00

(52) U.S. Cl. CPC A01N 43/50; A01N 25/02; A01N 25/30; A01N 37/22; A01N 43/54; A01P 13/00

(57) ABSTRACT

The present invention provides an herbicidal composition useful in controlling weed, comprising an imidazolinone-based acetolactate synthase (ALS) inhibitor dissolved in a particular organic solvent, and optionally one or more additional herbicides such as a very long chain fatty acid (VLCFA) inhibitor and a protoporpyrinogen oxidase (PPO) inhibitor.

### TECHNICAL FIELD

The present invention provides an herbicidal composition comprising an imidazolinone-based acetolactate synthase (ALS) inhibitor dissolved in a particular organic solvent, and optionally one or more additional herbicides such as a very long chain fatty acid (VLCFA) inhibitor and a protoporpyrinogen oxidase (PPO) inhibitor. The compositions of the invention are useful in controlling weed.

### BACKGROUND ART

Controlling weed or undesired vegetation is important to achieve high crop yield and quality. Often, crop cultures contain various undesired weeds and although herbicides can provide protection against a spectrum of weeds, they may not have any effect on certain type of weeds that might be present in the crop culture. Therefore, there is usually a strong need for using a mixture of herbicides.

Moreover, in crop protection, it is desirable to increase the specificity and the reliability of the action of active compounds, more particularly, to make sure said active compounds effectively control the harmful plants and, at the same time, are tolerated by the useful plants in question.

Mixtures of selected herbicides have several advantages over the use of a single herbicide including (a) an increase in the spectrum of weeds controlled or an extension of weed control over a longer period of time; (b) an improvement in crop safety and reduction in crop phytotoxicity by using minimum doses of selected herbicides applied in combination rather than a single high dose of one herbicide; and (c) a delay in the appearance of resistant weed species to selected herbicides (Damalas, 2004). Yet, it is often difficult to predict the activity and selectivity of a specific herbicide mixture, considering that the behavior of a specific herbicide in the mixture may be affected by the presence of the other(s), and the activity of the mixture may considerably vary depending on the chemical characters of the herbicides in the mixture, the plant species, the growth stage, and the environmental conditions. Mostly, this practice results in reduced activity of the herbicides in the mixture.

Saflufenacil (2-chloro-5-[3,6-dihydro-3-methyl-2,6-dioxo-4-(trifluoromethyl)-1-(2H)pyrimidinyl]-4-fluoro-N-[[methyl(1-methylethyl)amino]sulfonyl]benzamide) is a herbicide belonging to the group of protoporphyrinogen oxidase (PPO) inhibitors, more specifically a pyrimidinedione-based PPO inhibitor. Saflufenacil has been described in WO 01/083459. Further processes for its preparation are described in WO 03/097589, WO 05/054208, WO 06/097589, WO 06/125746, WO 08/043835, and WO 08/043836. Saflufenacil is particularly useful for preplant applications and selective pre-emergence weed control in multiple crops. In particular, it is useful as a foliar contact and residual broad-leaved weed herbicide. It is absorbed by foliage and roots with translocation in the apoplast and limited movement in the phloem. Saflufenacil is applied to foliage and is used for residual control of broad-leaved weeds, including glyphosate- and ALS-resistant biotypes. Saflufenacil is applied pre-emergence in corn and sorghum, at 50-125 gram/hectare (g/ha); preplant for rapid foliar burn-down in soybeans, cereals, cotton, legumes; and post-directed in tree fruit and nuts, at 18-25 g/ha, and in sugarcane at 24.5-96 g/ha.

Like many herbicides, salfufenacil is only sparingly soluble in water and mixtures of water with water-miscible solvents such as C₁-C₄-alkanols, C₂-C₄-alkandiols and C₂-C₄-alkantriols, and such aqueous dilutions may become instable. The solubility of saflufenacil in water, at 20° C., is 0.0025 g/100 mL and 0.21 g/100 mL, at pH 5 and 7, respectively. In methanol, isopropyl alcohol, and octanol, saflufenacil has a solubility of 2.98 g/100 mL, 0.25 g/100 mL, and <0.01 g/100 mL, respectively, at 20° C. (Pesticide Fact Sheet (saflufenacil); United States Environmental Protection Agency, Office of Prevention, Pesticides and Toxic Substances,August 2009;

https://www3.epa.gov/pesticides/chem search/reg_actions/registration/fs PC-118203 01 August 2009.pdf). Moreover, the saflufenacil-based aqueous dilutions sometimes show fluctuations in herbicidal efficiency.

When trying to formulate saflufenacil one faces several problems. Saflufenacil carries a N-amino-sulfonylcarboxamide side chain that might undergo hydrolysis at basic pH values (Roskamp et al., 2013). Apart from that, saflufenacil exists in different crystalline and non-crystalline modifications, i.e., amorphous forms, crystalline hydrates and a crystalline anhydrate, which may undergo uncontrolled interconversion. This interconversion may lead to coarsening of the saflufenacil particles, in particular when formulated as suspension concentrate. These factors might result in a reduced chemical and physical stability of the formulations, an effect that is particularly pronounced when the formulations are stored over prolonged periods of time and/or at elevated temperatures. Said factors may also lead to poor dilution properties as the coarse saflufenacil particles are prone to separate from the diluted formulation. Therefore, there is a need for water-free saflufenacil-based formulations in a non-aqueous media.

Imazethapyr (5-ethyl-2-[(R,S)-4-isopropyl-4-methyl-5-oxo-2-imidazolin-2-yl] nicotinic acid), an imidazolinone-based herbicidally active compound, is an inhibitor of acetolactate synthase (ALS), the enzyme participating in the biosynthesis of the branched-chain amino acids (valine, leucine, and isoleucine). Imazethapyr is amphoteric, having both carboxylic acid and basic pyridine functional groups.

Most herbicidal formulations containing imidazolinone-based ALS inhibitors, as the herbicidally active compound, are water-based, wherein said imidazolinone-based ALS inhibitors are present in a salt form, e.g., as a sodium or ammonium salt. Particularly, Imazethapyr 2 SL (ADAMA Ltd., Israel) is an herbicidal water-based formulation containing ammonium salt of imazethapyr (as the active ingredient) in 22.87% by weight, which is equivalent to 240 grams per liter of imazethapyr in its free acid form; and is suitable for use on alfalfa, clover, peas, beans, peanuts, and soybeans.

While having a relatively low water solubility (1415 mg/kg at 25° C., Stougaard et al., 1990), imidazolinone-based ALS inhibitors in their free acid form dissolve in certain organic solvents (48.2 g/L in acetone; 422.5 g/L in dimethyl sulfoxide, DMSO; 105 g/L in methanol; 184.8 g/L in methylene chloride; 17.3 g/L in 2-propanol; and 5.0 g/L in toluene, all at 25° C.; Imazethapyr. Yukiko Yamada, Ministry of Agriculture, Forestry and Fisheries, Tokyo, Japan;

http://www.fao.org/fileadmin/templates/agphome/documents/Pests_Pesticides/JMPR/Evalulation2016IMAZETHAPYR.pdf). Yet, those solvents are unsuitable for agricultural applications either because of their low flash point (e.g., acetone and methanol) or due to regulatory issues (e.g., DMSO).

U.S. Pat. No. 8,778,840 discloses soluble liquid (SL) formulations comprising quinclorac dimethylammonium as an herbicide, benzyl alcohol, and an additional herbicidal active ingredient such as imazethapyr.

There is a need to provide agriculturally acceptable non-aqueous formulations of imidazolinone-based herbicides, optionally further comprising additional herbicides having low water solubility and/or stability.

### SUMMARY OF INVENTION

It has now been found, in accordance with the present invention, that herbicides selected from imidazolinone-based acetolactate synthase (ALS) inhibitors such as imazethapyr and imazapic dissolve in organic solvents suitable for agricultural applications such as benzyl alcohol and ethyleneglycol phenyl ether. This finding is highly important, as it enables combining such imidazolinone-based herbicides with one or more hydrophobic herbicides or herbicides that are poorly stable in water, e.g., a pyrimidinedione-based protoporpyrinogen oxidase (PPO) inhibitor such as saflufenacil, in a single liquid formulation for use as an herbicidal composition. Such an herbicidal composition is highly beneficial since the application thereof to a locus such as a field of crop would be much more convenient than applying each one of the herbicides from a separate composition.

Moreover, and as shown herein, an herbicidal composition as proposed above, comprising imazethapyr, (S)-metolachlor and saflufenacil dissolved in benzyl alcohol (referred to herein as “a 3-way emulsifiable concentrate (EC) formulation”) was equivalent or superior to a tank mix consisting of three separate products each containing one of said three herbicides, in controlling both broad leaves- and grassy weeds such as Solanum nigrum, Xanthium strumarium, Amaranthus blitoides, Amaranthus retroflexus, Chenopodium album, Conyza bonariensis , Echinochloa colonum, Setaria viridis, and Digitaria sanguinalis.

In one aspect, the present invention thus provides a composition comprising an imidazolinone-based ALS inhibitor, such as imazethapyr, imazapic, imazamethabenz-methyl, imazapyr, imazamox, and imazaquin, as a herbicide, and a solvent of formula I:

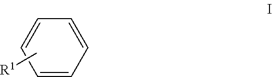

wherein R 1 is 1 to 4, preferably 1 to 3, substituents each independently selected from (C₁-C₆)alkylene-OH, —O—(C₁-C₆)alkylene-OH, (C₁-C₆)alkyl, and halogen, provided that at least one of R¹ is (C₁-C₆)alkylene-OH or —O—(C₁-C₆)alkylene-OH. Said composition may further comprise a surfactant, and/or at least one additional herbicide soluble/practically soluble in said solvent, e.g., a very long chain fatty acid (VLCFA) inhibitor, a PPO inhibitor, or a mixture thereof.

In another aspect, the present invention relates to methods for using an herbicidal composition as defined above. For example, in a particular such aspect, disclosed herein is a method of controlling weed comprising applying to a locus, such as a field of crop, an effective amount of such a composition.

In a further aspect, the present invention relates to an herbicide combination comprising saflufenacil, imazethapyr, and (S)-metolachlor.

### BRIEF DESCRIPTION OF DRAWINGS

FIG. 1A shows the efficacy (% control) at 26 days after application (DAA) of the saflufenacil-based formulations referred to herein as EC-1 and OD, and a tank mix referred to herein as tank mix-1, in controlling various weeds when applied pre-emergence at application rate (in gram of active ingredient per hectare; g ai/Ha) of 17.5 saflufenacil, 40 imazethapyr, and 500 (S)-metolachlor (equals to 70% of field target rate). *Conyza bonariensis was assessed at 30 DAA due to its late emergence.

FIG. 1B shows the efficacy (% control) at 15 days after application (DAA) of the saflufenacil-based formulations referred to herein as EC-1 and OD, and a tank mix referred to herein as tank mix-1, in controlling various weeds when applied post-emergence at application rate (in gram of active ingredient per hectare; g ai/Ha) of 1.75 saflufenacil, 4 imazethapyr, and 50 S-metolachlor (equals to 7% field target rate).

FIG. 2A shows the efficacy (% control) at 29 days after application (DAA) of the saflufenacil-based formulation referred to herein as EC-2 and the tank mix referred to herein as tank mix-2, in controlling various weeds when applied pre-emergence at application rate (in gram of active ingredient per hectare; g ai/Ha) of 19 saflufenacil, 50 imazethapyr, and 970 S-metolachlor (equals to 72% field target rate).

FIG. 2B shows the efficacy (% control) at 16 days after application (DAA) of the saflufenacil-based formulation referred to herein as EC-2 and the tank mix referred to herein as tank mix-2, in controlling various weeds when applied post-emergence at application rate (in gram of active ingredient per hectare; g ai/Ha) of 1.9 saflufenacil, 5 imazethapyr, and 97 S-metolachlor (equals to 72% field target rate).

### DETAILED DESCRIPTION

In one aspect, disclosed herein is a composition comprising an imidazolinone- based ALS inhibitor as an herbicide, and a solvent of formula I:

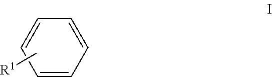

wherein R¹ is 1 to 4, i.e., one, two, three, or four, substituents each independently selected from (C₁-C₆)alkylene-OH, —O —(C₁-C₆)alkylene-OH, (C₁-C₆)alkyl, and halogen, provided that at least one of R¹ is (C₁-C₆)alkylene-OH or —O—(C₁-C₆)alkylene-OH.

The ALS enzyme, also known as acetohydroxy acid synthase (AHAS) enzyme, is a protein found in plants and micro-organisms, which catalyzes the first step in the synthesis of the branched-chain amino acids (valine, leucine, and isoleucine). Herbicides that inhibit ALS affect many species of higher plants as well as bacteria, fungi, yeasts, and algae. This class of chemicals slowly starve affected plants of these amino acids, which eventually leads to inhibition of DNA synthesis. They affect grasses and dicots alike. The ALS inhibitor family includes sulfonylureas, imidazolinones, triazolopyrimidines, pyrimidinyl benzoates, and sulfonylamino carbonyl triazolinines. Weeds quickly become resistant to ALS inhibitors, presumably because these herbicides have a single mode of action and because many have long residual activity (Whitcomb, 1999).

The term “alkyl” typically means a linear or branched hydrocarbyl having, e.g., 1-6 carbon atoms and includes, e.g., methyl, ethyl, n-propyl, isopropyl, n-butyl, sec-butyl, isobutyl, tert-butyl, n-pentyl, 2,2-dimethylpropyl, n-hexyl, and the like.

The term “alkylene” refers to a linear or branched divalent hydrocarbon group having, e.g., 1-6 carbon atoms. Examples of alkylenes include, without being limited to, methylene, ethylene, propylene, butylene, 2-methylpropylene, pentylene, 2-methylbutylene, hexylene, 2-methylpentylene, 3-methylpentylene, 2,3-dimethylbutylene, and the like.

The term “halogen” as used herein refers to a halogen and includes fluoro, chloro, bromo, and iodo, but it is preferably fluoro or chloro.

In certain embodiments, the imidazolinone-based ALS inhibitor comprised within the composition of the invention is imazethapyr, imazapic, imazamethabenz-methyl, imazapyr, imazamox, imazaquin, or a mixture thereof. In particular such embodiments, said imidazolinone-based ALS inhibitor is imazethapyr, imazapic, or a mixture thereof. More particular such compositions are those wherein said imidazolinone-based ALS inhibitor is imazethapyr. In all cases, it should be clear that the imidazolinone-based ALS inhibitor comprised within said composition is in its acid or base free form rather than a salt form, i.e., wherein all its acid and base groups are in their free acid and free base form.

In certain embodiments, the solvent composing the composition of the invention is a solvent of the formula I, wherein R¹ represents one substituent, two substituents, or three substituents, each independently as defined above. In certain particular such embodiments, R¹ represents a sole substituent selected from (C₁-C₆)alkylene-OH or —O—(C₁-C₆)alkylene-OH, preferably methylene-OH, ethylene-OH or oxyethylene-OH. In other particular such embodiments, R¹ represents two substituents attached to the phenyl ring at positions ortho or para to each other, preferably at positions para to each other, wherein one of said substituents is (C₁-C₆)alkylene-OH or —O—(C₁-C₆)alkylene-OH, preferably methylene-OH, ethylene-OH or oxyethylene-OH, and the other one of said substituents is (C₁-C₆)alkylene-OH, —O—(C₁-C₆)alkylene-OH, (C₁-C₆)alkyl, or halogen, preferably (C₁-C₆)alkyl such as methyl, ethyl and isopropyl, or halogen such as F, Cl and Br. In still other particular such embodiments, R i represents three substituents, wherein two of said three substituents are attached to the phenyl ring at positions ortho or para to each other, preferably at positions para to each other, wherein one or two of said substituents each independently is (C₁-C₆)alkylene-OH or —O—(C₁-C₆)alkylene-OH, preferably methylene-OH, ethylene-OH or oxyethylene-OH, and the other one or two substituents each independently is (C₁-C₆)alkylene-OH, —O—(C₁-C₆)alkylene-OH, (C₁-C₆)alkyl, or halogen, preferably (C₁-C₆)alkyl such as methyl, ethyl and isopropyl, or halogen such as F, Cl and Br.

In certain embodiments, the solvent composing the composition of the invention is phenyl methanol (benzyl alcohol), 2-phenoxyethanol (ethyleneglycol phenyl ether), 2-(p-tolyl)ethanol, 3-phenyl-propanol, 3-phenoxypropanol, 3-(4-chlorophenyl)propanol, 3-(4-fluorophenyl)propanol, or a mixture thereof.

In certain embodiments, the weight ratio between the imidazolinone-based ALS inhibitor and the solvent composing the composition of the invention is 1 to at least about 5, e.g., 1 to about 5, 5.5, 6, 6.5, 7, 7.5, 8, 8.5, 9, 9.5, or 10, respectively.

In certain embodiments, the composition of the invention according to any one of the embodiments defined above further comprises a surfactant.

The term “surfactant” as used herein refers to any agriculturally acceptable material which imparts or improves emulsifiability, spreading, wetting, dispersibility, or other surface-modifying properties of a herbicidal formulation, and optionally stability of said formulation, e.g., by inhibiting crystal growth or avoiding particle agglomeration. Non- limiting examples of surfactants include (i) nonionic surfactants such as fatty alcohol surfactants (e.g., cetyl alcohol), monoglyceride surfactants (e.g., glycerol monolaurate), polysorbate surfactants (e.g., Tween-20, Tween-40, Tween-60, Tween-65, Tween-80, and Tween-85), tristyrylphenol ethoxylate surfactants (e.g., Soprophor® TS/54), ethoxylated alkylphenol surfactants (e.g., a nonylphenol ethoxylate such as Tergitol NP-9™) ethoxylated arylphenol surfactants, ethoxylated castor oil surfactants (e.g., Alkamuls® OR/36, Stepantex® CO-40, and Stepantex® CO-36), ethylene oxide- and propylene oxide-block copolymers, and polyvinyl alcohol-vinyl acetate copolymers; (ii) anionic surfactants such as fatty acid sulfonates (e.g., lauryl sulfonate); (iii) cationic surfactants such as quaternary ammonium surfactants (e.g., cetylpyridinium chloride and dimethyldioctadecylammonium chloride); and (iv) ampholytic surfactants such as cocamidopropyl betaine and (3-[(3-Cholamidopropyl) dimethylammonio]-1-propanesulfonate).

In certain embodiments, disclosed herein is a composition comprising an imidazolinone-based ALS inhibitor, a solvent of formula I, and optionally a surfactant, wherein said imidazolinone-based ALS inhibitor is imazethapyr, imazapic, or a mixture thereof; said solvent is benzyl alcohol or ethyleneglycol phenyl ether; and said surfactant, when present, is a polysorbate surfactant such as Tween-20, Tween-40, Tween-60, Tween- 65, Tween-80 and Tween-85, a tristyrylphenol ethoxylate such as Soprophor® TS/54, an ethoxylated alkylphenol such as a nonylphenol ethoxylate, an ethoxylated arylphenol, or an ethoxylated castor oil such as Alkamuls® OR/36, Stepantex® CO-40 and Stepantex® CO-36. More particular such compositions are those comprising imazethapyr or imazapic; benzyl alcohol; and Tween-20.

In certain embodiments, the composition of the invention according to any one of the embodiments defined above further comprises at least one additional herbicide, more specifically an herbicide that is unstable in an aqueous media, and soluble, or practically soluble, in said solvent of the formula I. Categories of such additional herbicides include, without limiting, VLCFA inhibitors and PPO inhibitors.

The Herbicide Resistance Action Committee (HRAC) classifies herbicides into different groups according to their target sites, modes of action, symptoms induced, and/or chemical classes. One of those groups are the K₃ group, which includes, e.g., acetamide-, chloroacetamide-, oxyacetamide-, and tetrazolinone-based herbicides. Herbicides of the K₃ group are capable of inhibiting VLCFA (fatty acids >C18) biosynthesis in plant and algal cells. In higher plants, VLCFAs serve as components, or precursors in the synthesis, of wax, suberin, and cutin, which form the leaf cuticle; as storage lipids in seeds; as periderm and endodermis components; as glycosylphosphatidylinositol (GPI) anchors in plasma membrane proteins; and as sphingolipid components in various membranes. VLCFAs are formed by membrane-bound, multienzyme acyl-CoA elongase systems that catalyze a series of biochemical reactions analogous to those of de novo fatty acid synthase (Trenkamp et al., 2004).

Non-limiting examples of VLCFA inhibitors include acetamide-based VLCFA inhibitors such as napropamide, naproanilide, and diphenamid; oxyacetamide-based VLCFA inhibitors such as flufenacet and mefenacet; chloroacetamide-based VLCFA inhibitors such as acetochlor, dimethachlor, metolachlor (including (S)-metolachlor, (R)-metolachlor, as well as any mixture thereof such as a racemate thereof), dimethenamid (including (S)-dimethenamid, (R)-dimethenamid, as well as any mixture thereof such as a racemate thereof), alachlor, butachlor, butenachlor, delachlor, prynachlor, terbuchlor, allidochlor, xylachlor, 2-chloro-N,N-diethylacetamide (CDEA), diethatyl, metazachlor, pethoxamid, pretilachlor, propachlor, propisochlor, and thenylchlor; tetrazolinone-based VLCFA inhibitors such as fentrazamide, and ipfencarbazone; anilofos; cafenstrole; piperophos; pyroxasulfone; epronaz; tridiphane; indanofan; and enantiomers thereof.

(S)-metolachlor(2-chloro-N-(2-ethyl-6-methylphenyl)-N-[(1S)-2-methoxy-1-methyethyl] acetamide) is a selective and systemic herbicide which controls weeds by inhibiting the synthesis of long chain fatty acids. This herbicide is particularly used as a pre-emergent herbicide for controlling annual grasses and small-seeded broadleaf weeds in more than 70 agricultural crops worldwide such as corn, soybeans, potatoes, sugar beets, sunflowers, and tomatoes (Zemolin et al., 2014).

Protoporphyrinogen oxidase (PPO) is an enzyme in the chloroplast that oxidizes protoporphyrinogen IX (PPGIX) to form protoporphyrin IX (PPIX), which is a precursor for both chlorophyll (needed for photosynthesis) and heme (needed for electron transfer chains). Inhibition of PPO, however, not only block the syntheses of chlorophyll and heme, but also results in forming highly reactive molecules that attack and destroy lipids and protein membranes. When a lipid membrane is destroyed, the cell becomes leaky and the cell organelles rapidly dry and disintegrate. PPO inhibitors have limited translocation in plants and sometimes are referred to as contact herbicides. These herbicides injure mostly broadleaf plants; however, some of them affect grasses as well, and they are used to control weeds in field crops, vegetables, tree fruits and vines, small fruits, nurseries, lawns, and industry.

PPO inhibitors include diphenylethers, N-phenylphthalimides, oxadiazoles, oxazolidinediones, phenylpyrazoles, pyrimidindiones, thiadiazoles, and triazolinones. Specific such herbicides include, without limiting, diphenyl ether-based PPO inhibitors such as bifenox, fomesafen, oxyfluorfen, lactofen, halosafen, fluoroglycofen-ethyl, chlomethoxyfen, acifluorfen-sodium, and ethoxyfen-ethyl; phenylpyrazole-based PPO inhibitors such as fluazolate and pyraflufen-ethyl; thiadiazole-based PPO inhibitors such as fluthiacet-methyl and thidiazimin; pyrimidinedione-based PPO inhibitors such as benzfendizone, butafenacil, and saflufenacil; N-phenyl-phthalimide-based PPO inhibitors such as cinidon-ethyl, flumiclorac-pentyl, and flumioxazin; flufenpyr-ethyl; pyraclonil; profluazol; oxazolidinedione-based PPO inhibitors such as pentoxazone; triazolinone-based PPO inhibitors such as sulfentrazone, carfentrazone-ethyl, azafenidin, and bencarbazone; and ozadiazole-based PPO inhibitors such as oxadiazon and oxadiargyl.

In particular such embodiments, the composition of the invention according to any one of the embodiments above further comprises at least one additional herbicide selected from a VLCFA inhibitor and a PPO inhibitor, wherein said VLCFA inhibitor is (S)-metolachlor; and said PPO inhibitor is saflufenacil. More particular such compositions comprise a mixture of both (S)-metolachlor and saflufenacil.

Compositions according to the present invention comprising one or more herbicides in addition to said imidazolinone-based ALS inhibitor, as defined in any one of the embodiments above, may further comprise a co-solvent.

The term “co-solvent” as used herein refers to a substance (solvent) that may be added to a primary solvent in small amounts so as to increase the solubility of a poorly-soluble compound in the primary solvent. Particular co-solvents for use in the composition of the invention include, without being limited to, aromatic hydrocarbons such as alkylbenzenes and alkylnaphthalenes; alcohols such as methanol, cyclohexanol and decanol; glycols such as ethylene glycol, polypropylene glycol, and dipropropylene glycol; N,N-dimethylformamide; dimethylsulfoxide; N-alkylpyrrolidone; paraffins; oils of olive, castor, linseed, tung, sesame, corn, peanut, cotton-seed, soybean, rape-seed, and coconut; fatty acid esters; ketones such as cyclohexanone, 2-heptanone, isophorone and 4-hydroxy-4-methyl-2-pentanone; and dimethylamide esters such as pentanoic acid 5-(dimethylamino)-2-methyl-5-oxo-methyl ester (e.g., Rhodiasolv® PolarClean, which is a product containing pentanoic acid 5-(dimethylamino)-2-methyl-5-oxo-methyl ester (methyl 5-(dimethylamino)-2-methyl-5-oxopentanoate) and up to about 5% by weight diamide, i.e., N¹,N¹,N⁵,N⁵ ,2-pentamethylpentanediamide, rests, i.e., wherein the ratio between said ester and said diamide is 20:1).

In certain embodiments, the composition of the invention comprises an imidazolinone-based ALS inhibitor and a solvent of formula I, each as defined in any one of the embodiments above, and further comprises a surfactant; at least one additional herbicide selected from a VLCFA inhibitor, a PPO inhibitor, and a mixture thereof; and a co-solvent. Particular such compositions comprise, as said at least one additional herbicide, a mixture of a VLCFA inhibitor and a PPO inhibitor. In particular embodiments, such a composition comprises about 0.5% to about 5% by weight said imidazolinone-base ALS inhibitor; about 5% to about 60% by weight said solvent; about 10% to about 70% by weight said surfactant; about 15% to about 45% by weight said VLCFA inhibitor; about 0.1% to about 2.5% by weight said PPO inhibitor; and about 0.5% to about 7% by weight said co-solvent. Examples of such compositions are those wherein the imidazolinone-based ALS inhibitor is imazethapyr; the solvent is benzyl alcohol; the surfactant is Tween-20; the VLCFA inhibitor is (S)-metolachlor; the PPO inhibitor is saflufenacil; and the co-solvent is pentanoic acid 5-(dimethylamino)-2-methyl-5-oxo-methyl ester. More specific such compositions comprise about 0.5% to about 2% by weight imazethapyr; about 10% to about 20% by weight benzyl alcohol; about 60% to about 70% by weight Tween-20; about 15% to about 25% by weight (S)-metolachlor; about 0.2% to about 1% by weight saflufenacil; and about 0.5% to about 2% by weight pentanoic acid 5-(dimethylamino)-2-methyl-5-oxo-methyl ester.

In another aspect, the present invention relates to various agricultural uses, e.g., pre- and/or post-emergence weed control, in which a composition as defined in any one of the embodiments above is utilized.

In one particular such aspect, disclosed herein is a method of controlling weed, also referred to herein as undesired vegetation, comprising applying to a locus an effective amount of a composition as defined herein, in any one of the embodiments above.

The term “locus” as used herein refers not only to areas where the weed may already be developed, but also to areas where weeds have yet to emerge, and to areas under cultivation. Locus includes the crop and propagation material of the crop (all the generative parts of the crop such as seeds and vegetative plant material such as cuttings and tubers, which can be used for the multiplication of the plant). Examples of propagation material of the crop include seeds, tubers, spores, corms, bulbs, rhizomes, sprouts basal shoots, stolons, buds and other parts of plants, including seedlings and young plants, which could be transplanted after germination or after emergence from soil. Locus also includes the area surrounding the crop and the growing media of the crop, such as soil and crop field.

In certain embodiments, the locus is a field of crop. The term “crop” (or “plant”) as used herein refers to whole plants, plant organs (e.g., leaves, stems, twigs, roots, trunks, limbs, shoots, fruits, etc.), plant cells, or plant seeds. Non-limiting examples of crops are cotton, rice, banana, potato, coffee, sugar cane, citrus, beans, sunflower, apple, corn, soybean, wheat, barley, oats, chickpeas, fruit trees, nut trees, lentils, and grain sorghum. Yet, it should be clear that the list of crops provided herein is general, and the particular crop(s) treatable according to the method of the invention will depend on the specific herbicides comprised within the composition applied to the locus (for example, only clearfield varieties of wheat, sunflower, rice, rape, and maize are tolerant to certain imidazolinones). The specific herbicides composing said composition may also affect the decision whether the composition is to be applied to the locus treated pre- or post-emergence of weeds.

Weeds that can be controlled by the method of the present invention include any weed, e.g., an annual or perennial grass or broad-leaved weed, that is sensitive to at least one of the herbicides comprised within the composition applied, i.e., to either the imidazolinone-based ALS inhibitor or at least one of the additional one or more herbicides optionally comprised within the composition, and thus could be controlled by either pre- or post-emergence application of said herbicide. Non-limiting examples of such weeds are Setaria viridis, Amaranthus blitoides, Amaranthus retroflexus, Digitaria sanguinalis, Solanum nigrum, Conyza bonariensis, Chenopodium album, Echinochloa colonum, and Xanthium strumarium.

In certain embodiments, the composition used according to the method disclosed herein comprises an imidazolinone-based ALS inhibitor and a solvent of formula I, each as defined above, and further comprises a surfactant; at least one additional herbicide selected from a VLCFA inhibitor, a PPO inhibitor, and a mixture thereof; and a co-solvent. Particular such compositions comprise, as said at least one additional herbicide, a mixture of a VLCFA inhibitor and a PPO inhibitor. In particular embodiments, such a composition comprises about 0.5% to about 5% by weight said imidazolinone-base ALS inhibitor; about 5% to about 60% by weight said solvent; about 10% to about 70% by weight said surfactant; about 15% to about 45% by weight said VLCFA inhibitor; about 0.1% to about 2.5% by weight said PPO inhibitor; and about 0.5% to about 7% by weight said co-solvent. Examples of such compositions are those wherein the imidazolinone-based ALS inhibitor is imazethapyr; the solvent is benzyl alcohol; the surfactant is Tween-20; the VLCFA inhibitor is (S)-metolachlor; the PPO inhibitor is saflufenacil; and the co-solvent is pentanoic acid 5-(dimethylamino)-2-methyl-5-oxo-methyl ester. More specific such compositions comprise about 0.5% to about 2% by weight imazethapyr; about 10% to about 20% by weight benzyl alcohol; about 60% to about 70% by weight Tween-20; about 15% to about 25% by weight (S)-metolachlor; about 0.2% to about 1% by weight saflufenacil; and about 0.5% to about 2% by weight pentanoic acid 5-(dimethylamino)-2-methyl-5-oxo-methyl ester.

Based on the data shown in the experimental section herein, it is postulated that an herbicide combination comprising saflufenacil, imazethapyr, and (S)-metolachlor, per se, i.e., regardless of the particular formulation thereof, may have a synergistic effect in controlling weed, i.e., undesired vegetation, as compared to each one of the three herbicides listed when applied separately.

In a further aspect, the present invention thus relates to an herbicide combination comprising saflufenacil, imazethapyr, and (S)-metolachlor.

Unless otherwise indicated, all numbers expressing, e.g., amounts of components or ratios between components, used in this specification, are to be understood as being modified in all instances by the term “about”. Accordingly, unless indicated to the contrary, the numerical parameters set forth in this specification are approximations that may vary by up to plus or minus 10% depending upon the desired properties to be obtained by the present invention.

The invention will now be illustrated by the following non-limiting Examples.

### EXAMPLES

### Materials and Methods

Imazapic (98% purity) was purchased from Nutrichem Co., Ltd; imazethapyr (98% purity) was purchased from Shandong Cynda Chemical Co., Ltd.; benzyl alcohol (technical grade) was purchased from Sigma Aldrich; Tween-20 was purchased from Croda Crop Care; saflufenacil (96% purity) was obtained from ADAMA Ltd.; (S)- metolachlor (99% purity) was purchased from Shandong Binnong Technology Co., Ltd; and Rhodiasolv® PolarClean was purchased from Rhodia Poliamida e Especialidades Ltd.

### Example 1. Preparation of Imazapic-Based Formulation

A formulation comprising imazapic, benzyl alcohol and Tween-20 as detailed in Table 1 was prepared by (i) adding benzyl alcohol to a reactor; adding Tween-20 while mixing; (iii) gradually adding imazapic and continue mixing until the solution obtained is clear; (iv) discharging said solution from the reactor; and (v) filtering the solution using a 5 μm filter. The filtered formulation obtained was transparent and completely soluble in water at tank mix concentrations (benzyl alcohol has solubility of about 3.5% in water).

TABLE 1

| Component | Amount (gram) |
|---|---|
| imazapic | 10 |
| benzyl alcohol | 89 |
| Tween-20 | 1 |

### Example 2. Preparation of Imazethapyr-Based Formulation

A formulation comprising imazethapyr, benzyl alcohol and Tween-20 as detailed in Table 2 was prepared following the same procedure described in Example 1 (wherein imazapic is replaced by imazethapyr). The filtered formulation obtained was transparent and completely soluble in water at tank mix concentrations.

TABLE 2

| Component | Amount (gram) |
|---|---|
| imazethapyr | 10 |
| benzyl alcohol | 89 |
| Tween-20 | 1 |

Example 3. Preparation of a 3-Way Formulation Comprising (S)-metolachlor, imazethapyr, and saflufenacil

A representative formulation comprising (S)-metolachlor, imazethapyr, and saflufenacil as detailed in Table 3 was prepared by (i) preparing a solution of the saflufenacil in Rhodiasolv® Polarclean to a reactor; (ii) adding (S)-metolachlor, benzyl alcohol, imazethapyr, and Tween-20, and mixing until a clear solution is formed; (iii) discharging said solution from the reactor; and (iv) filtering the solution using a 5 μm filter. Such formulations are transparent, produce emulsion at tank mix concentrations, and referred to herein as “3-way emulsifiable concentrate (EC) formulations”.

TABLE 3

| Component | % by weight |
|---|---|
| (S)-metolachlor | 18.5 |
| imazethapyr | 1.02 |
| saflufenacil | 0.42 |
| Rhodiasolv ® PolarClean | 1.3 |
| benzyl alcohol | 14.4 |
| Tween-20 | 64.36 |

Example 4. The Efficacy of 3-Way Formulations Comprising (S)-metolachlor, imazethapyr, and saflufenacil

Objective. Evaluating the efficacy under greenhouse conditions of ready-mix formulations containing saflufenacil, imazethapyr and (S)-metolachlor (3-way EC formulations) on various weed species; and comparing it with tank mix of commercial solo formulations of the same active ingredients applied at equivalent rate.

Location. Trials were conducted on behalf of ADAMA Ltd. at the Department of Weed Research in Newe-Ya'ar Research Center, Agricultural Research Organization, Ramat Yishay, Israel.

Materials and methods. All seeds were sown in plastic pots (pot volume of 300 cc) filled with Newe Ya' ar soil (medium-heavy clay-loam soil). From this stage and until the end of the experiment plants were kept in a temperature-controlled greenhouse (35-20° C.). Herbicide application was done outside the greenhouse in a dedicated chamber. Spray application was performed using motorized sprayer equipped with a flat fan 8001E nozzle 4 and operated at a pressure of 300 kPa with spray volume equivalent to 200 L/Hectare. Application of treatments was done using a common practice of applying from the lower to the higher rate and with water-rinsing of the equipment between applications. After herbicide application, pots were transferred back to greenhouse and were sprinkler-irrigated to a field capacity 4-hours after herbicide application. The formulations were applied either as pre-emergence or as post-emergence of the treated weeds. All the tested formulations were mixed with water before application.

Assessments. Each treatment was performed in 5 repetitions and an un-treated control was included for each weed species. Weed control was assessed using a visual evaluation of 0-100 percentage scale, where 0=complete control and 100=no effect.

The tested weeds used in Trials 1-4 below were Solanum nigrum, Xanthium strumarium, Amaranthus blitoides, Amaranthus retroflexus, Chenopodium album, Conyza bonariensis, Echinochloa colonum, Setaria viridis, and Digitaria sanguinalis.

### Trial 1. Pre-Emergence Treatment

The saflufenacil formulations, saflufenacil 14 gr/L +imazethapyr 32 gr/L+S-metolachlor 400 gr/L (referred to herein as “3-way EC-1 formulation”, EC-1); and saflufenacil 26 gr/L+imazethapyr 60 gr/L+(S)-metolachlor 745 gr/L (referred to herein as “oil dispersion formulation”, OD) were compared to a tank mix (a mix of available products, each comprising a different one of saflufenacil, (S)- metolachlor, and imazethapyr, in water) and applied pre-emergence. The tested weeds were: Solanum nigrum, Xanthium strumarium, Amaranthus blitoides, Chenopodium album, Conyza bonariensis, Echinochloa colonum, Setaria viridis, and Digitaria sanguinalis

The tank mix (referred to herein as “tank mix-1”) was composed of Eragon® LQ, which is a water-based suspension concentrate (SC) formulation sold by BASF (active ingredient: saflufenacil, 342 g/L); Vezir® 240 SL, which is a soluble liquid (SL) formulation sold by ADAMA (active ingredient: imazethapyr, 240 g/L); and Dual Gold, which is an emulsifiable concentrate formulation sold by Syngenta (active ingredient: (S)-metolachlor, 960 g/L). Table 4 summarizes the application rate of the saflufenacil-based formulations and the tank mix, wherein the saflufenacil tested rate was calculated as 70% from field target rate of 25 g ai/Ha (gram active ingredient per hectare).

TABLE 4

| | | | g ai/Ha | | |
|---|---|---|---|---|---|
| | | | | | (S)- |
| Entry | Formulation | ml/Ha | saflufenacil | imazethapyr | metolachlor |
| 0 | untreated | | | | |
| | control | | | | |
| 1 | EC-1 | 1250 | 17.5 | 40 | 500 |
| 2 | OD | 673 | 17.5 | 40 | 500 |
| 3 | Tank mix-1 | 51 + | 17.5 | 40 | 500 |
| | | 167 + | | | |
| | | 521 | | | |

g ai/Ha = gram active ingredient per hectare

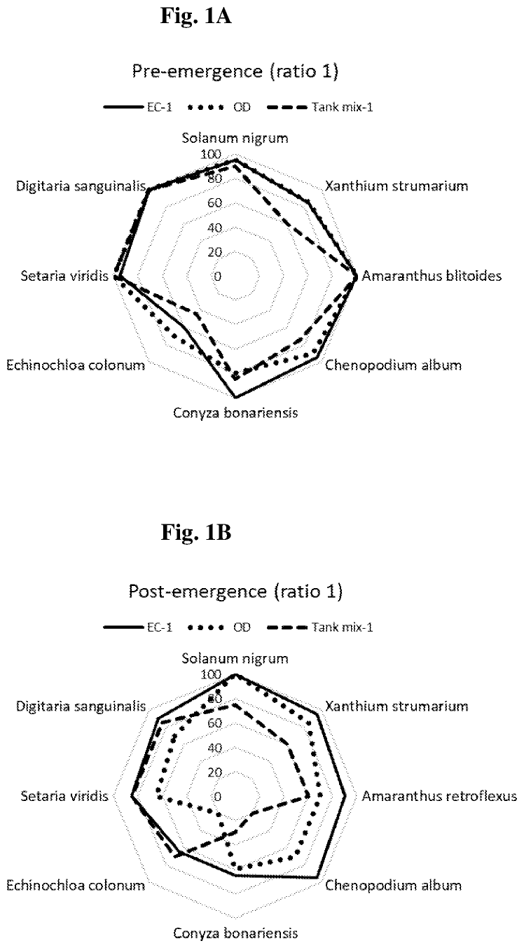

Results. The efficacy of the tested formulations as compared to the tank mix, applied pre-emergence, in controlling the various weeds tested is shown in FIG. 1A. Both the EC-1 and the OD formulations were shown to be superior or equivalent to the tank mix- 1 in weeds control, at 26 days after application.

### Trial 2. Post-Emergence Treatment

The two saflufenacil-based formulations tested in Trial 1 were compared to tank mix-1 and applied post-emergence. Table 5 summarizes the application rate of the saflufenacil-based formulations and the tank mix, wherein the saflufenacil tested rate was calculated as 7% from field target rate of 25 g ai/Ha (active ingredient per hectare). Merge adjuvant (BASF) was added to all tested treatments according to the recommended label rate, at 0.5% of the total tank spray volume (v/v), i.e., the total volume obtained after mixing the tested formulation with water, before application.

TABLE 5

| | | | g ai/Ha | | | Merge |
|---|---|---|---|---|---|---|
| Entry | Formulation | ml/Ha | saflufenacil | imazethapyr | (S)-metolachlor | 0.5% v/v |
| 0 | untreated control | | | | | |
| 1 | EC-1 | 125.0 | 1.75 | 4.00 | 50.00 | + |
| 2 | OD | 67.3 | 1.75 | 4.00 | 50.00 | + |
| 3 | Tank mix-1 | 5.1 + 16.7 + 52.1 | 1.75 | 4.00 | 50.00 | + |

g ai/Ha = gram active ingredient per hectare

Results. The efficacy of the tested formulations as compared to the tank mix, applied post-emergence, in controlling the various weeds tested is shown in FIG. 1B. Both the EC-1 and the OD formulations were shown to be superior or equivalent to the tank mix in weeds control, at 15 days after application.

The tested weed list and growth stage at application are shown in Table 6.

TABLE 6

| Hight (cm) | Leaves (no.) | Weed (Latin name) |
|---|---|---|
| 2-7 | 2-3 | Digitaria sanguinalis |
| 3-6 | 2-3 | Solanum nigrum |
| 2-4 | 3-6 | Conyza bonariensis |
| 3-6 | Up to 6 | Chenopodium album |
| 4-6 | 2-3 | Echinochloa colonum |
| 8-12 | 4 | Xanthium strumarium |
| 3-10 | 2-3 | Setaria verticillata |
| 5-10 | 3-4 | Amaranthus retroflexus |

### Trial 3. Pre-Emergence Treatment

A saflufenacil-based formulation containing saflufenacil 9.6 gr/L +imazethapyr 26 gr/L+(S)-metolachlor 500 gr/L (referred to herein as “3-way EC-2 formulation”, EC-2) was compared to a tank mix (a mix of available products, each comprising a different one of saflufenacil, (S)-metolachlor, and imazethapyr, applied as a mixture) and applied pre-emergence. The tested weeds were: Solanum nigrum, Xanthium strumarium, Amaranthus blitoides, Chenopodium album, Conyza bonariensis, Echinochloa colonum, Setaria viridis, and Digitaria sanguinalis.

The tank mix (referred to herein as “tank mix-2”) is composed of Eragon® LQ; Vezir® 240 SL; and Dual Gold, IL which is an emulsifiable concentrate formulation sold by Syngenta (active ingredient: (S)-metolachlor at a concentration of 915 g/L). Table 7 summarizes the application rate of the saflufenacil-based formulation and the tank mix, wherein the saflufenacil tested rate was calculated as 72% from field target rate of 26 g ai/Ha (active ingredient per hectare).

TABLE 7

| | | | g ai/Ha | | |
|---|---|---|---|---|---|
| | | | | | (S)- |
| Entry | Formulation | ml/Ha | saflufenacil | imazethapyr | metolachlor |
| 0 | untreated | | | | |
| | control | | | | |
| 1 | EC-2 | 1939 | 18.62 | 50.42 | 969.58 |
| 2 | Tank mix-2 | 54 + | 18.62 | 50.12 | 965.88 |
| | | 209 + | | | |
| | | 1056 | | | |

g ai/Ha = gram active ingredient per hectare

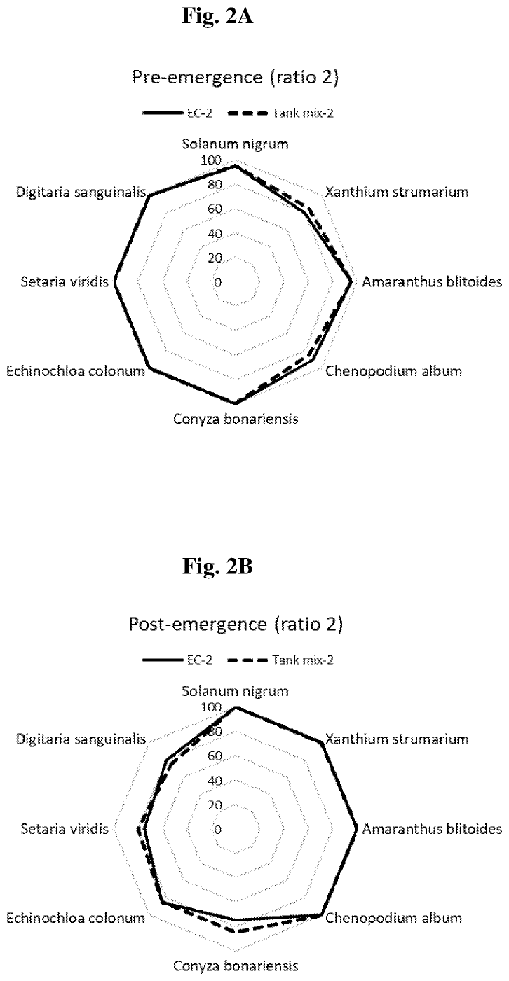

Results. The efficacy of the tested formulation as compared to the tank mix, applied pre-emergence, in controlling the various weeds tested is shown in FIG. 2A. The EC-2 formulation was found to be equivalent to the tank mix in performance in all tested weeds, at 29 days after application.

### Trial 4. Post-Emergence Treatment

The saflufenacil-based formulation tested in Trial 3 was compared to tank mix-2 and applied post-emergence. Table 8 summarizes the application rate of the saflufenacil-based formulation and the tank mix, wherein the saflufenacil tested rate was calculated as 7.2% from field target rate of 26 g ai/Ha (active ingredient per hectare). Shatah 90 adjuvant (ADAMA) was added to all tested treatments according to the recommended label rate, at 0.5% of the total tank spray volume (v/v).

TABLE 8

| | | | g ai/Ha | | | Shatah 90, |
|---|---|---|---|---|---|---|
| Entry | Formulation | ml/Ha | saflufenacil | imazethapyr | (S)-metolachlor | 0.5% v/v |
| 0 | untreated control | | | | | |
| 1 | EC-2 | 194 | 1.86 | 5.04 | 96.96 | + |
| 2 | Tank mix-2 | 5.4 + 21 + 105.5 | 1.86 | 5.04 | 96.96 | + |

g ai/Ha = gram active ingredient per hectare

The tested weed list and growth stage at application are shown in Table 9.

Results. The efficacy of the tested formulation as compared to the tank mix, applied post-emergence, in controlling the various weeds tested is shown in FIG. 2B. EC-2 was found to be equivalent to the tank mix in controlling the various weeds tested in post-emergence application, at 16 days after application.

TABLE 9

| Hight (cm) | Leaves (no.) | Weed (Latin name) |
|---|---|---|
| 2-7 | 2-3 | Digitaria sanguinalis |
| 3-6 | 2-3 | Solanum nigrum |
| 2-4 | 3-6 | Conyza bonariensis |
| 3-6 | up to 6 | Chenopodium album |
| 4-6 | 2-3 | Echinochloa colonum |
| 8-12 | 4 | Xanthium strumarium |
| 3-10 | 2-3 | Setaria verticillata |
| 5-10 | 3-4 | Amaranthus blitoides |

### REFERENCES

Damalas, C.A ., Herbicide tank mixtures: common interactions. Int. J. Agric. Biol., 2004, 6, 209-212

Roskamp, J. M.; Turco, R. F.; Bischoff, M.; Johnson, W., The influence of carrier water pH and hardness of saflufenacil efficacy and solubility. Weed Technology, 2013, 27, 527-533

Stougaard, R. N.; Shea, P. J.; Martin, A. R., Effect of soil and pH on adsorption, mobility, and efficacy of imazaquin and imazethapyr. Weed Science, 1990, 38, 67-73

Trenkamp, S.; Martin, W.; Tietjen, K., Specific and differential inhibition of very-long-chain fatty acid elongases from Arabidopsis thaliana by different herbicides. Proceedings of the National Academy of Sciences, 2004, 101, 11903-11908 Whitcomb, C. E., An ontroduction to ALS-inhibiting herbicides. Toxicol Ind Health, 1999, 15, 231-239

Zemolin, C. R.; Avila, L. A.; Cassol, G. V.; Massey, J. H.; Camargo, E. R., Environmental fate of S-metolachlor—A review. Planta Daninha, 2014, 32, 655-664

1. A composition comprising an imidazolinone-based acetolactate synthase (ALS) inhibitor as a herbicide, and a solvent of formula I: 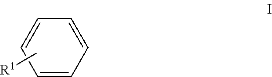
wherein R¹ is 1 to 4 substituents each independently selected from (C₁-C₆)alkylene-OH, O—(C₁-C₆)alkylene-OH, (C₁-C₆)alkyl, and halogen, provided that at least one of R¹ is (C₁-C₆)alkylene-OH or O—(C₁-C₆)alkylene-OH.

2. The composition of claim 1, wherein said imidazolinone-based ALS inhibitor is imazethapyr, imazapic, imazamethabenz-methyl, imazapyr, imazamox, imazaquin, or a mixture thereof.

3. The composition of claim 2, wherein said imidazolinone-based ALS inhibitor is imazethapyr, imazapic, or a mixture thereof, preferably imazethapyr.

4. The composition of claim 1, wherein R¹ represents one substituent, or two substituents preferably attached to the ring at positions para to each other.

5. The composition of claim 4, wherein one of R¹ is methylene-OH, ethylene-OH, or oxyethylene-OH; and the other R¹, when present, is (C₁-C₆)alkyl, or halogen.

6. The composition of claim 5, wherein one of R¹ is methylene-OH, ethylene-OH, or oxyethylene-OH; and the other R¹, when present, is methyl, ethyl, F, Cl, or Br.

7. The composition of claim 1, wherein said solvent is phenyl methanol (benzyl alcohol), 2-phenoxyethanol (ethyleneglycol phenyl ether), 2-(p-tolyl)ethanol, 3-phenyl-propanol, 3-phenoxypropanol, 3-(4-chlorophenyl)propanol, 3-(4-fluorophenyl)propanol, or a mixture thereof.

8. The composition of claim 1, wherein the weight ratio between said imidazolinone-based ALS inhibitor and said solvent is 1:at least about 5, respectively.

9. The composition of claim 1, further comprising a surfactant.

10. The composition of claim 9, wherein said surfactant is a polysorbate surfactant such as Tween-20, Tween-40, Tween-60, Tween-65, Tween-80 and Tween-85; a tristyrylphenol ethoxylate such as Soprophor® TS/54; an ethoxylated alkylphenol such as a nonylphenol ethoxylate; an ethoxylated arylphenol; or an ethoxylated castor oil such as Alkamuls® OR/36, Stepantex® CO-40, and Stepantex® CO-36.

11. The composition of claim 1, wherein said imidazolinone-based ALS inhibitor is imazethapyr, imazapic, or a mixure thereof; said solvent is phenyl methanol (benzyl alcohol) or 2- phenoxyethanol (ethyleneglycol phenyl ether); and said composition optionally further comprises a surfactant.

12. The composition of claim 10, wherein said surfactant is a polysorbate surfactant such as Tween-20, Tween-40, Tween-60, Tween-65, Tween-80 and Tween-85; a tristyrylphenol ethoxylate such as Soprophor® TS/54; an ethoxylated alkylphenol such as a nonylphenol ethoxylate; an ethoxylated arylphenol; or an ethoxylated castor oil such as Alkamuls® OR/36, Stepantex® CO-40, and Stepantex® CO-36.

13. The composition of claim 12, comprising imazethapyr or imazapic; phenyl methanol (benzyl alcohol); and Tween-20.

14. The composition of claim 1, further comprising at least one additional herbicide.

15. The composition of claim 14, wherein said at least one additional herbicide is a very long chain fatty acid (VLCFA) inhibitor, a protoporpyrinogen oxidase (PPO) inhibitor, or a mixture thereof.

16. The composition of claim 15, wherein
(i) said VLCFA inhibitor is an acetamide-based VLCFA inhibitor such as napropamide, naproanilide, and diphenamid; an oxyacetamide-based VLCFA inhibitor such as flufenacet and mefenacet; a chloroacetamide-based VLCFA inhibitor such as acetochlor, dimethachlor, metolachlor, dimethenamid, xylalachlor, butachlor, butenachlor, delachlor, prynachlor, terbuchlor, allidochlor, xylachlor, 2-chloro-N,N-diethylacetamide (CDEA), diethatyl, metazachlor, pethoxamid, pretilachlor, propachlor, propisochlor, and thenylchlor; a tetrazolinone-based VLCFA inhibitor such as fentrazamide, and ipfencarbazone; anilofos; cafenstrole; piperophos; pyroxasulfone; epronaz; tridiphane; indanofan; or an enantiomer thereof; or
(ii) said PPO inhibitor is a diphenyl ether-based PPO inhibitor such as bifenox, fomesafen, oxyfluorfen, lactofen, halosafen, fluoroglycofen-ethyl, chlomethoxyfen, acifluorfen- sodium, and ethoxyfen-ethyl; a phenylpyrazole-based PPO inhibitor such as fluazolate and pyraflufen-ethyl; a thiadiazole-based PPO inhibitor such as fluthiacet-methyl and thidiazimin; a pyrimidinedione-based PPO inhibitor such as benzfendizone, butafenacil, and saflufenacil; a N-phenyl-phthalimide-based PPO inhibitor such as cinidon-ethyl, flumiclorac-pentyl, and flumioxazin; flufenpyr-ethyl; pyraclonil;
profluazol; an oxazolidinedione-based PPO inhibitor such as pentoxazone; a triazolinone-based PPO inhibitor such as sulfentrazone, carfentrazone-ethyl, azafenidin, and bencarbazone; or an ozadiazole-based PPO inhibitor such as oxadiazon and oxadiargyl.

17. The composition of claim 16, wherein said VLCFA inhibitor is (S)-metolachlor;
and said PPO inhibitor is saflufenacil.

18. The composition of claim 17, wherein said at least one additional herbicide is a mixture of (S)-metolachlor and saflufenacil.

19. The composition of claim 14, further comprising a co-solvent.

20. The composition of claim 19, wherein said co-solvent is pentanoic acid 5-(dimethylamino)-2-methyl-5-oxo-methyl ester (such as Rhodiasolv® PolarClean).

21. The composition of claim 1, further comprising: (i) a surfactant; (ii) at least one additional herbicide selected from a VLCFA inhibitor, a PPO inhibitor, and a mixture thereof; and (iii) a co-solvent.

22. The composition of claim 21, wherein said at least one additional herbicide is a mixture of a VLCFA inhibitor and a PPO inhibitor.

23. The composition of claim 22, comprising about 0.5% to about 5% by weight said imidazolinone-base ALS inhibitor; about 5% to about 60% by weight said solvent; about 10% to about 70% by weight said surfactant; about 15% to about 45% by weight said VLCFA inhibitor; about 0.1% to about 2.5% by weight said PPO inhibitor; and about 0.5% to about 7% by weight said co-solvent.

24. The composition of claim 23, wherein said imidazolinone-based ALS inhibitor is imazethapyr; said solvent is benzyl alcohol; said surfactant is Tween-20; said VLCFA inhibitor is (S)-metolachlor; said PPO inhibitor is saflufenacil; and said co-solvent is pentanoic acid 5-(dimethylamino)-2-methyl-5-oxo-methyl ester.

25. The composition of claim 24, comprising about 0.5% to about 2% by weight imazethapyr; about 10% to about 20% by weight benzyl alcohol; about 60% to about 70% by weight Tween-20; about 15% to about 25% by weight (S)-metolachlor; about 0.2% to about 1% by weight saflufenacil; and about 0.5% to about 2% by weight pentanoic acid 5-(dimethylamino)-2-methyl-5-oxo-methyl ester.

26. A method of controlling weed comprising applying to a locus an effective amount of a composition according to claim 1.

27. The method of claim 26, wherein said locus is a field of crop.

28. The method of claim 27, wherein said crop is selected from cotton, rice, banana, potato, coffee, sugar cane, citrus, beans, sunflower, apple, corn, soybean, wheat, barley, oats, chickpeas, fruit trees, nut trees, lentils, and grain sorghum.

29. The method of claim 26, wherein said weed is Setaria viridis, Amaranthus blitoides, Amaranthus retroflexus, Digitaria sanguinalis, Solanum nigrum, Conyza bonariensis, Chenopodium album, Echinochloa colonum, or Xanthium strumarium.

30. An herbicide combination comprising saflufenacil, imazethapyr, and (S)-metolachlor.
